(19) United States
(12) Patent Application Publication
(10) Pub. No.: US 2026/0287386 A1
(43) Pub. Date: Sep. 24, 2026

(54) CONTROL DEVICE, CONTROL METHOD, AND STORAGE MEDIUM

(71) Applicant: HONDA MOTOR CO., LTD., Tokyo (JP)

(72) Inventor: Keiki OKANO, Tokyo (JP)

(73) Assignee: HONDA MOTOR CO., LTD., Tokyo (JP)

(21) Appl. No.: 19/572,902

(22) Filed: Mar. 20, 2026

(30) Foreign Application Priority Data
Mar. 21, 2025 (JP) 2025-046275

(51) Int. Cl. G01C 21/36; B60K 35/81

(52) U.S. Cl. CPC G01C 21/3658; B60K 35/81; B60K 2360/166

(57) ABSTRACT

A control device includes a processor configured to acquire peripheral information of a host vehicle, and display, when the host vehicle turns right or left from a host lane in which the host vehicle travels to enter a target lane connected to the host lane, a route from the host lane to the target lane to an occupant of the host vehicle based on the peripheral information. When an oncoming lane of the target lane exists on a roadway including the target lane and a division line separating the target lane and the oncoming lane of the target lane does not exist or is not detected, the processor displays a division mark separating the target lane and the oncoming lane of the target lane in display of the route.

### CROSS-REFERENCE TO RELATED APPLICATIONS

This application is based on and claims priority under 35 USC 119 from Japanese Patent Application No. 2025-046275 filed on March 21, 2025, the entire content of which is incorporated herein by reference.

### TECHNICAL FIELD

The present disclosure relates to a control device, a control method, and a non-transitory storage medium storing a control program.

### BACKGROUND ART

In recent years, improvements in traffic safety have been required to enable inclusion, safety, toughness, and sustainability of urban and human residents. From the viewpoint of improving the traffic safety, for example, development of a driving assistance technique and an autonomous driving technique for vehicles has been advanced.

As an example of a driving assistance technique, a technique is known in which, in a driving system capable of automatic lane change, a travel lane to which the lane change is possible is displayed on a display screen to notify a user of a route.

For example, JP2005-202787A describes a vehicle display device that determines a level of attention that a user should pay based on traffic regulation instruction information for a road ahead of a host vehicle, generates a display image showing an area of the road with a different display mode according to the determined level of attention, and displays the generated display image at a position of the road within a display area of a windshield.

### SUMMARY OF INVENTION

However, when a vehicle travels from a travel lane to a target lane that is different from the travel lane, the vehicle may travel to a target lane on a road with no center line, or travel to a target lane from a road of the travel lane with no center line. In this case, a driver may prioritize ease of travel for the host vehicle and advance to the target lane while swerving into an oncoming lane, thereby interfering with traveling of other vehicles.

JP2005-202787A describes, for example, displaying the opposite lane adjacent to the travel lane of the host vehicle in a color different from that of the travel lane of the host vehicle, and displaying a future travel trajectory of the host vehicle, but does not disclose displaying of a display image when traveling to a road with no center line or when traveling from a road with no center line to another road.

Aspects of non-limiting embodiments of the present disclosure relates to providing a control device, a control method, and a non-transitory storage medium storing a control program capable of appropriately displaying a route of a vehicle.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a control device including a processor configured to acquire peripheral information of a host vehicle, and display, when the host vehicle turns right or left from a host lane in which the host vehicle travels to enter a target lane connected to the host lane, a route from the host lane to the target lane to an occupant of the host vehicle based on the peripheral information, in which, when an oncoming lane of the target lane exists on a roadway including the target lane and a division line separating the target lane and the oncoming lane of the target lane does not exist or is not detected, the processor displays a division mark separating the target lane and the oncoming lane of the target lane in display of the route.

According to an aspect of the present disclosure, there is provided a control device, including a processor configured to acquire peripheral information of a host vehicle, and display, when the host vehicle enters from a host lane in which the host vehicle travels to a target lane connected to the host lane, a route from the host lane to the target lane to an occupant of the host vehicle based on the peripheral information, in which, when an oncoming lane of the host lane exists on a roadway including the host lane and a division line separating the host lane and the oncoming lane of the host lane does not exist or is not detected, the processor displays a division mark separating the host lane and the oncoming lane of the host lane in display of the route.

According to an aspect of the present disclosure, there is provided a control method of a control device including a processor, the processor configured to acquire peripheral information of a host vehicle, and display, when the host vehicle turns right or left from a host lane in which the host vehicle travels to enter a target lane connected to the host lane, a route from the host lane to the target lane to an occupant of the host vehicle based on the peripheral information, the control method including displaying, when an oncoming lane of the target lane exists on a roadway including the target lane and a division line separating the target lane and the oncoming lane of the target lane does not exist or is not detected, a division mark separating the target lane and the oncoming lane of the target lane in display of the route.

According to an aspect of the present disclosure, there is provided a non-transitory computer-readable storage medium storing a control program for a processor of a control device to perform processing, the processor configured to acquire peripheral information of a host vehicle, and display, when the host vehicle turns right or left from a host lane in which the host vehicle travels to enter a target lane connected to the host lane, a route from the host lane to the target lane to an occupant of the host vehicle based on the peripheral information, the processing including displaying, when an oncoming lane of the target lane exists on a roadway including the target lane and a division line separating the target lane and the oncoming lane of the target lane does not exist or is not detected, a division mark separating the target lane and the oncoming lane of the target lane in display of the route.

The present disclosure can provide a control device, a control method, and a non-transitory storage medium storing a control program capable of appropriately displaying a route of a vehicle.

### BRIEF DESCRIPTION OF DRAWINGS

Exemplary embodiment(s) of the present invention will be described in detail based on the following figures, wherein:

FIG. 1 is a side view of a vehicle 1 in which a control device according to an exemplary embodiment of the present invention is installed;

FIG. 2 is a top view of the vehicle 1 illustrated in FIG. 1;

FIG. 3 is a block diagram illustrating an example of an internal configuration of the vehicle 1 illustrated in FIG. 1;

FIG. 4 is a flowchart showing an example of processing of a control device 30 during traveling of a host vehicle 1a;

FIG. 5 is a diagram illustrating a first example of information on a traveling route of the host vehicle 1a displayed in a peripheral image;

FIG. 6 is a diagram illustrating a second example of the information on the traveling route of the host vehicle 1a displayed in the peripheral image;

FIG. 7 is a diagram illustrating a third example of the information on the traveling route of the host vehicle 1a displayed in the peripheral image;

FIG. 8 is a diagram illustrating a fourth example of the information on the traveling route of the host vehicle 1a displayed in the peripheral image;

FIG. 9 is a diagram illustrating a fifth example of the information on the traveling route of the host vehicle 1a displayed in the peripheral image;

FIG. 10 is a diagram illustrating a sixth example of the information on the traveling route of the host vehicle 1a displayed in the peripheral image;

FIG. 11 is a diagram illustrating a seventh example of the information on the traveling route of the host vehicle 1a displayed in the peripheral image;

FIG. 12 is a diagram illustrating an eighth example of the information on the traveling route of the host vehicle 1a displayed in the peripheral image;

FIG. 13 is a diagram illustrating a ninth example of the information on the traveling route of the host vehicle 1a displayed in the peripheral image; and

FIG. 14 is a diagram illustrating a tenth example of the information on the traveling route of the host vehicle 1a displayed in the peripheral image.

### DESCRIPTION OF EMBODIMENTS

Hereinafter, an embodiment of a control device, a control method, and a non-transitory storage medium storing a control program of the present disclosure will be described with reference to the drawings. The drawings are viewed in directions of reference signs. Note that the following embodiment does not limit the present invention, and not all of elements described in the following embodiment are essential to the present invention. Hereinafter, the same or similar elements are denoted by the same or similar reference signs, and description thereof may be omitted or simplified.

### 1. Vehicle

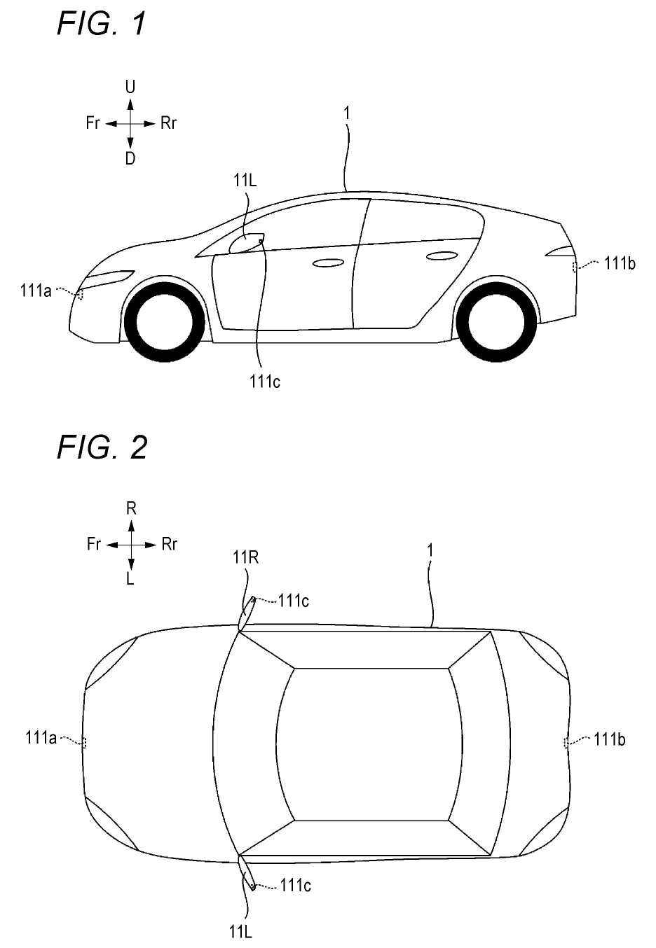

FIG. 1 is a side view of a vehicle 1 in which a control device according to an exemplary embodiment of the present invention is installed. FIG. 2 is a top view of the vehicle 1 illustrated in FIG. 1. The vehicle 1 according to the present embodiment is an automobile including a drive source (not illustrated), and wheels (not illustrated) including drive wheels driven by power of the drive source and steered wheels that are steerable. As an example, the vehicle 1 may be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. The front wheels and the rear wheels of the vehicle 1 may all be steerable steered wheels, or the front wheels or the rear wheels may be steerable steered wheels.

The vehicle 1 further includes side mirrors 11L and 11R. The side mirrors 11L and 11R are mirrors (back mirrors) provided on outer sides of front seat doors of the vehicle 1 for a driver to check a rear side and rear lateral sides. The side mirrors 11L and 11R are fixed to a main body of the vehicle 1 by rotation shafts extending in a vertical direction, and can be opened and closed by rotating about the rotation shafts.

The vehicle 1 further includes a front camera 111a, a rear camera 111b, and side cameras 111c. The front camera 111a is a digital camera that is provided on a front side of the vehicle 1 and images the front side of the vehicle 1. The rear camera 111b is a digital camera that is provided on a rear side of the vehicle 1 and images the rear side of the vehicle 1. The side cameras 111c are digital cameras that are respectively provided on the left and right side mirrors 11L and 11R of the vehicle 1 and images a left or right side of the vehicle 1.

### 2. Internal Configuration of Vehicle

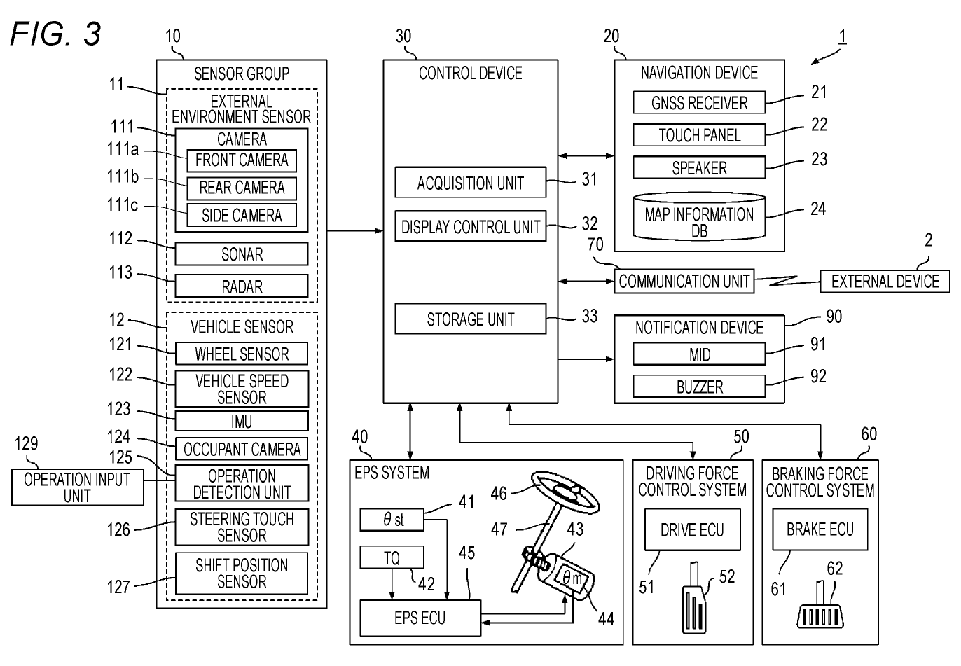

FIG. 3 is a block diagram illustrating an example of an internal configuration of the vehicle 1 illustrated in FIG. 1. The vehicle 1 includes a sensor group 10, a navigation device 20, a control device 30, an electric power steering (EPS) system 40, a driving force control system 50, a braking force control system 60, a communication unit 70, and a notification device 90.

The sensor group 10 includes an external environment sensor 11 that acquires peripheral information for recognizing a periphery (in other words, surroundings) of the vehicle 1, and a vehicle sensor 12 that acquires information on the vehicle 1 (hereinafter, also referred to as "vehicle information"). The information acquired by each sensor in the sensor group 10 is output to the control device 30, and is used for control of the vehicle 1 (hereinafter, also referred to as "vehicle control") performed by the control device 30.

The external environment sensor 11 includes, for example, cameras 111, a sonar 112, and a radar 113. The cameras 111 image the periphery of the vehicle 1 including the front side of the vehicle 1, and output image data of an obtained peripheral image to the control device 30. Such image data is an example of the peripheral information. As the camera 111, for example, a digital camera using an imaging element such as a charge coupled device (CCD) or a complementary metal oxide semiconductor (CMOS) can be adopted.

More specifically, the cameras 111 include, for example, a front camera 111a, a rear camera 111b, and side cameras 111c. The front camera 111a is provided, for example, on an upper portion of a front windshield or a front grille (not illustrated) of the vehicle 1, and images a scene in front of the vehicle 1. The rear camera 111b is provided, for example, near a license plate (in other words, an automobile registration number mark) attached to a rear portion of the vehicle 1, and captures an image of a scene behind the vehicle 1. The side cameras 111c are provided, for example, on the left and right side mirrors 11L and 11R, and image scenes on lateral sides (that is, the left and right sides) of the vehicle 1. The peripheral images of the vehicle 1 captured by the front camera 111a, the rear camera 111b, the side camera 111c on the left side, and the side camera 111c on the right side are also referred to as a front image, a rear image, a left side image, and a right side image, respectively. An image constituted by the left side image and the right side image may be referred to as a lateral side image. The peripheral image of the vehicle 1 generated by combining the imaging data of the front camera 111a, the rear camera 111b, and the left and right side cameras 111c may be referred to as a top view image.

The sonar 112 emits sound waves to the periphery of the vehicle 1 (for example, the front side, the rear side, and the lateral sides of the vehicle 1), and receives reflected sounds from an object present in the periphery of the vehicle 1, thereby detecting a distance to the object from the vehicle 1, an azimuth of the object, and the like, and outputs the detection result to the control device 30. The detection result of the sonar 112 is another example of the peripheral information.

The radar 113 emits radio waves to the periphery of the vehicle 1 including the front side of the vehicle 1, and receives reflected waves from an object present in the periphery of the vehicle 1, thereby detecting a distance to the object, an azimuth of the object, and the like. As the radar 113, for example, a millimeter wave radar can be adopted. The detection result of the radar 113 is another example of the peripheral information.

Note that the external environment sensor 11 may include light detection and ranging (LiDAR) instead of or in addition to the sonar 112 and the radar 113. In this case, the LiDAR emits laser light to the periphery of the vehicle 1 including the front side of the vehicle 1, and receives reflected light from an object present in the periphery of the vehicle 1, thereby detecting a distance to the object from the vehicle 1, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, a steering touch sensor 126, and a shift position sensor 127.

The wheel sensor 121 detects a rotation angle of one or more wheels among the wheels of the vehicle 1. As an example, the wheel sensor 121 detects rotation angles of the left rear wheel and the right rear wheel. As the wheel sensor 121, for example, an angle sensor or a displacement sensor can be adopted.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a countershaft (not illustrated) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. Note that the vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of an obtained interior image to the control device 30. For example, the occupant camera 124 can be a so-called "driver monitor camera" that can capture an image of a head of an occupant seated in a driver seat of the vehicle 1 (for example, a user driving the vehicle 1, hereinafter simply referred to as "user") from the front. As the occupant camera 124, a digital camera using an imaging element such as a CCD or a CMOS can be adopted, similarly to the camera 111.

The operation detection unit 125 detects an operation performed using an operation input unit 129 operable by the user. The operation input unit 129 may include, for example, a switch or a button that receives a command related to traveling assistance to be described later.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the user when the steering 46 is gripped appropriately.

The shift position sensor 127 detects, for example, whether a shift position of a shift lever (not illustrated) provided in the vehicle 1 is any one of "P (parking)", "R (reverse)", "N (neutral)", and "D (drive)". When the vehicle 1 may take another shift position (for example, "B (brake)") other than the "P", the "R", the "N", and the "D", the shift position sensor 127 may also detect whether the shift position is the other shift position.

The navigation device 20 includes, for example, a global navigation satellite system (GNSS) receiver 21, a touch panel 22, and a speaker 23. The navigation device 20 also includes a storage unit (not illustrated) implemented by a flash memory or the like. The storage unit of the navigation device 20 stores a map information database (DB) 24 and the like.

The map information database 24 includes road network information. The road network information is information representing roads based on a combination of nodes and links connecting the nodes (also referred to as "paths"). Each of the nodes in the road network information represents, for example, a feature of the corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating nodes at both ends of the link, a road corresponding to the link, a link length, a lane number, a traveling direction, a road type, and the like is set.

The GNSS receiver 21 specifies a current position of the vehicle 1 (for example, a latitude and a longitude of a location where the vehicle 1 is at) based on a signal received from a GNSS satellite. Note that the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

For example, the touch panel 22 is implemented by combining a display device such as a liquid crystal display or an organic light emitting diode (OLED) with a pointing device (for example, a touch pad). The speaker 23 is configured to output a sound to the occupant of the vehicle 1 including the user. The touch panel 22 is an example of the notification unit that can issue a notification to the user. The speaker 23 is another example of the notification unit capable of issuing a notification to the user.

For example, the navigation device 20 searches for, by referring to the map information database 24, a route from the current position of the vehicle 1 to a destination set by the user using the touch panel 22. Then, the navigation device 20 performs route guidance using the touch panel 22 and the speaker 23 based on the found route.

Further, the navigation device 20 may cause the touch panel 22 to perform a predetermined display according to an instruction from the control device 30. Further, the navigation device 20 may output predetermined information (for example, information indicating an operation received via the touch panel 22) to the control device 30.

For example, the navigation device 20 may cause, according to the instruction from the control device 30, the touch panel 22 to display an operation button for receiving a command request related to traveling assistance. Further, the navigation device 20 may output, to the control device 30, operation information of the command request related to the traveling assistance received via the touch panel 22. The "traveling assistance" is vehicle control capable of causing (guiding) the vehicle 1 to travel from a current traveling position of the vehicle 1 to a target traveling position according to information on a traveling route. The traveling assistance can be used, for example, when the vehicle 1 is traveling on a travel lane with insufficient information on the traveling route. The traveling assistance displays the information on the traveling route, thereby causing (guiding) the vehicle 1 to travel along an appropriate traveling route to a target position.

Specifically, the navigation device 20 causes the touch panel 22 to display traveling assistance buttons for requesting the traveling assistance of the vehicle 1. The traveling assistance buttons include a traveling assistance support button for requesting support when the vehicle 1 travels by operations of the driver, and an automatic traveling assistance button for requesting support when the vehicle 1 travels by automatic steering of the control device 30. When the traveling assistance button is operated via the touch panel 22, the navigation device 20 outputs this operation information to the control device 30.

The navigation device 20 causes the touch panel 22 to display the top view image in which the vehicle 1 and the periphery of the vehicle 1 are overlooked. Further, the navigation device 20 causes the touch panel 22 to display a three-dimensional (3D) image in which the peripheral image of the vehicle 1 and an image of the vehicle 1 are superimposed. Note that although the touch panel 22 of the navigation device 20 is used as an input device or a display device in the present example, for example, a head-up display (HUD), a smartphone, a tablet terminal, or the like may be used.

The control device 30 is an example of the control device according to the present embodiment and is a computer that integrally controls the entire vehicle 1. The control device 30 includes, for example, a processor (not illustrated) that performs various calculations, a storage unit 33 including a non-transitory storage medium that stores various types of information (for example, programs and various types of data), and an input and output unit (not illustrated) as an interface that controls input and output of data between inside and outside of the control device 30.

The control device 30 also includes an acquisition unit 31 and a display control unit 32 as functional units implemented by the processor executing the programs stored in the storage unit 33. These functional units will be described later, and thus the description thereof will be omitted here. Note that for example, the control device 30 is implemented by one electronic control unit (ECU) or by a plurality of ECUs working in cooperation with each other.

The EPS system 40 includes, for example, a steering angle sensor 41, a torque sensor 42, an EPS motor 43, a resolver 44, and an EPS ECU 45.

The steering angle sensor 41 detects a steering angle θst of a steering 46 and outputs information indicating the detected steering angle θst to the EPS ECU 45. The torque sensor 42 detects a steering torque TQ, which is a torque applied to the steering 46 of the vehicle 1, and outputs information indicating the detected steering torque TQ to the EPS ECU 45.

The EPS motor 43 assists the user in operating the steering 46 by applying, according to an instruction from the EPS ECU 45, a driving force or a reaction force to a steering column 47 coupled to the steering 46. The resolver 44 detects a rotation angle θm of the EPS motor 43 and outputs information indicating the detected rotation angle θm to the EPS ECU 45.

The EPS ECU 45 is a computer which includes, for example, a processor that performs various calculations, a storage unit including a non-transitory storage medium that stores various types of information, and an input and output unit that controls input and output of data between the inside and the outside of the EPS ECU 45 (none is illustrated), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, and the rotation angle θm detected by the resolver 44. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a drive ECU 51, and is configured to control a driving force of the vehicle 1. The drive ECU 51 is a computer that includes, for example, a processor that performs various calculations, a storage unit including a non-transitory storage medium that stores various types of information, and an input and output unit that controls input and output of data between the inside and the outside of the drive ECU 51 (none is illustrated), and controls the driving force control system 50. The drive ECU 51 is implemented by one or more ECUs. For example, the drive ECU 51 controls power output from the drive source of the vehicle 1, based on an operation on an accelerator pedal 52 provided in the vehicle 1. The drive ECU 51 can also control the driving force control system 50 (for example, the drive source) according to an instruction from the control device 30.

The braking force control system 60 includes a brake ECU 61, and is configured to control a braking force of the vehicle 1. The brake ECU 61 is a computer that includes, for example, a processor that performs various calculations, a storage unit including a non-transitory storage medium that stores various types of information, and an input and output unit that controls input and output of data between the inside and the outside of the brake ECU 61 (none is illustrated), and controls the braking force control system 60. The brake ECU 61 is implemented by one or more ECUs. For example, the brake ECU 61 controls the braking force of the vehicle 1 by controlling a brake device (not illustrated) provided in the vehicle 1, based on an operation on a brake pedal 62 provided in the vehicle 1. Here, the brake device includes, for example, a brake caliper, a cylinder that transmits a hydraulic pressure to the brake caliper, and an electric motor that generates the hydraulic pressure in the cylinder. The brake ECU 61 controls the electric motor of the brake device such that a braking force corresponding to the operation on the brake pedal 62 is generated. The brake ECU 61 can also control the braking force control system 60 (for example, the brake device) according to an instruction from the control device 30.

The communication unit 70 is a communication interface that communicates with an external device 2 under the control of the control device 30. That is, the control device 30 may communicate with the external device 2 via the communication unit 70. Examples of the external device 2 include a terminal device (for example, a smartphone) of the user and a server device managed by a manufacturer of the vehicle 1. Note that for example, a mobile communication network such as a cellular line, WI-FI (registered trademark), or Bluetooth (registered trademark) can be used for the communication between the vehicle 1 and the external device 2.

The notification device 90 is a device that issues a notification (for example, an alarm) to the user under the control of the control device 30. The notification device 90 includes, for example, a multi-information display (MID) 91 and a buzzer 92.

The MID 91 is implemented by a display device such as a liquid crystal display or an OLED, and is provided at a position that can be visually recognized by the user (for example, in a meter panel of the vehicle 1). For example, the MID 91 displays a predetermined image according to an instruction from the control device 30. The MID 91 is another example of the notification unit capable of issuing a notification to the user. Note that the MID 91 may be integrated with the touch panel 22 described above.

The buzzer 92 is configured to output a predetermined sound. For example, the buzzer 92 outputs a predetermined alarm sound or a sound effect according to an instruction from the control device 30. The buzzer 92 is another example of the notification unit capable of issuing a notification to the user. Note that the buzzer 92 may be integrated with the speaker 23 described above.

Next, each functional unit (acquisition unit 31, display control unit 32) of the control device 30 will be described in detail. The acquisition unit 31 acquires peripheral information on a surrounding situation of a host vehicle 1a. The acquisition unit 31 acquires the peripheral information from, for example, the external environment sensor 11. The host vehicle 1a is an example of the vehicle 1. Note that in the following description, it is assumed that the host vehicle 1a travels on a left side of a road as regulated in, for example, Japan. The left side is an example of a "first direction side" of the present embodiment. Therefore, the host vehicle 1a turning in the first direction means turning left, and specifically means turning in an opposite direction of a direction of crossing an oncoming lane of a host lane or an oncoming lane of a target lane. the host vehicle 1a turning in an opposite direction of the first direction means turning right, and specifically means turning in a direction crossing the oncoming lane of the host lane or the oncoming lane of the target lane. The "oncoming lane of the host lane" refers to an oncoming lane that has a traveling direction opposite to that of the host lane. The "oncoming lane of the target lane" refers to an oncoming lane that has a traveling direction opposite to that of the target lane. Note that the "first direction" in the present embodiment is a lane width direction, which is the left direction in countries where people drive on the left side of a road, and the right direction in countries where people drive on the right side of a road. Here, a country where people drive on the left side of a road is assumed, and the first direction is the left direction as described above, but in a country where people drive on the right side of a road, the first direction is the right direction.

Based on the peripheral information of the host vehicle 1a, when the host vehicle 1a turns right or left from a host lane where the host vehicle 1a travels to enter a target lane connected to the host lane, the display control unit 32 displays a route from the host lane to the target lane to an occupant of the host vehicle 1a. The "target lane connected to the host lane" refers to, for example, a lane that the host vehicle 1a is going to travel next and that the host vehicle 1a can move to from a lane in which the host vehicle 1a is currently traveling. "When ... to enter" refers to a case where the entering is scheduled, and may refer to, for example, a case where the entering is scheduled in the navigation device 20, a state in which a turn signal is on, and a case where the entering is scheduled based on a recognition result of road signs and the like. The display control unit 32 displays the route of the host vehicle 1a via, for example, the touch panel 22 of the navigation device 20.

When an oncoming lane of the target lane exists on a roadway including the target lane, and a division line separating the target lane and the oncoming lane does not exist or is not detected, the display control unit 32 displays a division mark separating the target lane and the oncoming lane in the display of the route from the host lane to the target lane. The "roadway including the target lane" refers to a roadway including a lane into which the host vehicle 1a turns right or left to enter. "Separating the target lane and the oncoming lane" means separating the target lane and the oncoming lane thereof in a vehicle width direction. The "division line" refers to a lane boundary line, including, for example, a center line of a roadway. The "division mark" refers to a virtual division mark, and specifically may be any mark that allows the user to recognize the boundary.

When the oncoming lane of the target lane exists, and the division line separating the target lane and the oncoming lane does not exist or is not detected, and when the host vehicle 1a turns left to enter the target lane, the display control unit 32 displays the division mark separating the target lane and the oncoming lane in the display of the route from the host lane to the target lane on condition that an oncoming vehicle exists in the oncoming lane of the target lane. When the host vehicle 1a turns left, the display control unit 32 does not display the division mark if there is no oncoming vehicle in the oncoming lane of the target lane. On the other hand, when the host vehicle 1a turns right, the display control unit 32 displays the division mark regardless of whether there is an oncoming vehicle in the oncoming lane of the target lane.

When an oncoming lane of the host lane exists on a roadway including the host lane, and a division line separating the host lane and the oncoming lane exists or is detected, the display control unit 32 displays a connection mark connecting the division line separating the host lane and the oncoming lane and the division mark displayed to separate the target lane and the oncoming lane thereof. The "roadway including the host lane" refers to a roadway including a lane in which the host vehicle 1a is currently traveling. The "connection mark" is a line (for example, a curve) that connects the division line and the division mark. The connection mark does not have to completely connect the division line and the division mark.

When an oncoming lane of the target lane exists on a roadway including the target lane, and a division line separating the target lane and the oncoming lane does not exist or is not detected, when an oncoming lane of the host lane exists on a roadway including the host lane, and a division line separating the host lane and the oncoming lane does not exist or is not detected, and when the host vehicle 1a turns right from the host lane to enter the target lane, the display control unit 32 displays a first division mark separating the host lane and the oncoming lane thereof and a second division mark separating the target lane and the oncoming lane thereof in the display of the route from the host lane to the target lane.

When an oncoming lane of the target lane exists on a roadway including the target lane, and a division line separating the target lane and the oncoming lane does not exist or is not detected, when an oncoming lane of the host lane exists on a roadway including the host lane, and a division line separating the host lane and the oncoming lane does not exist or is not detected, and when the host vehicle 1a turns left from the host lane to enter the target lane, the display control unit 32 displays, in the display of the route from the host lane to the target lane, a first division mark separating the host lane and the oncoming lane thereof, and displays a second division mark separating the target lane and the oncoming lane thereof on condition that an oncoming vehicle exists in the oncoming lane of the target lane.

The display control unit 32 displays a connection mark that connects the first division mark displayed to separate the host lane and the oncoming lane thereof and the second division mark displayed to separate the target lane and the oncoming lane thereof.

When an oncoming lane of the host lane exists on a roadway including the host lane, and a division line separating the host lane and the oncoming lane does not exist or is not detected, the display control unit 32 displays a division mark separating the host lane and the oncoming lane in the display of the route from the host lane to the target lane. "Separating the host lane and the oncoming lane" means separating the host lane and the oncoming lane thereof in a vehicle width direction.

When an oncoming lane of the target lane exists on a roadway including the target lane, and a division line separating the target lane and the oncoming lane exists or is detected, the display control unit 32 displays a connection mark connecting the division line displayed to separate the host lane and the oncoming lane thereof and the division mark separating the target lane and the oncoming lane thereof.

### 3. Processing of Control Device

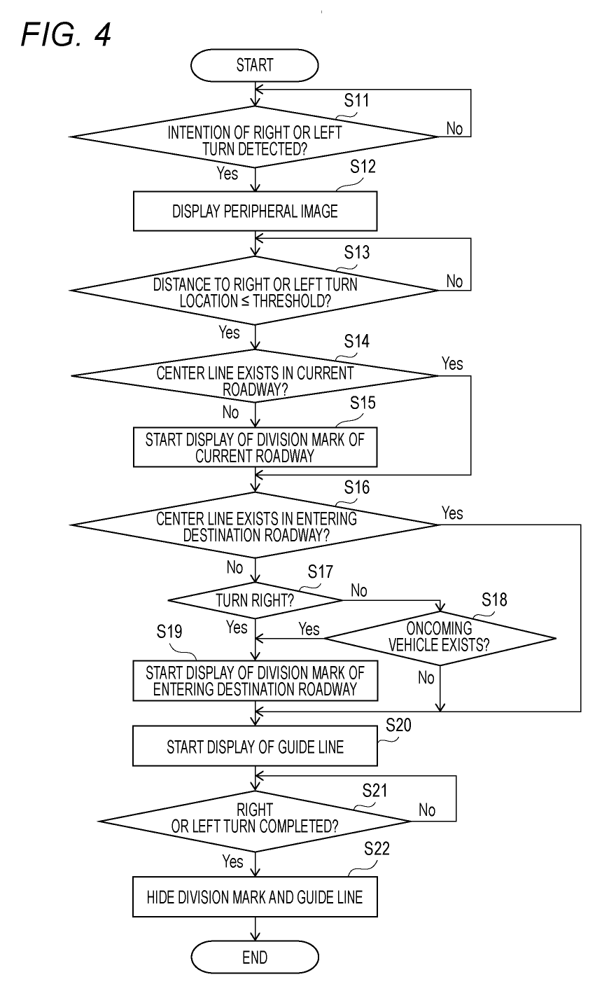

FIG. 4 is a flowchart showing an example of processing of the control device 30 during traveling of the host vehicle 1a. The processing of this example is started, for example, when the navigation device 20 is started and the traveling assistance button (traveling assistance support button, automatic traveling assistance button) on the touch panel 22 is touched. However, the processing may be started simultaneously with the start of the navigation device 20. The processing may be started simultaneously with an ignition of the host vehicle 1a being turned on.

First, the control device 30 detects whether the host vehicle 1a has an intention to turn right or left (step S11). The control device 30 performs the detection by, for example, determining whether a right turn or a left turn is scheduled in the navigation device 20, or whether the turn signal of the host vehicle 1a is turned on.

If an intention to turn right or left is not detected in step S11 (step S11: No), the control device 30 repeats the processing of step S11. If an intention to turn right or left is detected in step S11 (step S11: Yes), the control device 30 displays a peripheral image of the host vehicle 1a on the touch panel 22 (step S12). The peripheral image is an image on which information on a traveling route (division mark, connection mark, and the like) is superimposed in this processing. The peripheral image can be displayed as, for example, a top view image, a front view image, a 3D image, or the like. Note that the peripheral image may be displayed at all times while the host vehicle 1a is traveling, regardless of whether an intention to turn right or left is detected.

Next, the control device 30 determines whether a distance from the host vehicle 1a to a right or left turn location is equal to or less than a predetermined threshold (step S13). If it is determined in step S13 that the distance to the right or left turn location is not equal to or less than the threshold (step S13: No), the control device 30 repeats the processing of step S13.

If it is determined in step S13 that the distance to the right or left turn location is equal to or less than the threshold (step S13: Yes), the control device 30 determines whether there is a center line separating a host lane and an oncoming lane thereof on a roadway on which the host vehicle 1a is currently traveling (step S14).

If it is determined in step S14 that there is no center line on the roadway on which the host vehicle 1a is traveling (step S14: No), the control device 30 starts processing of displaying, on the roadway on which the host vehicle 1a is traveling, a division mark separating the host lane and the oncoming lane thereof (step S15).

Next, the control device 30 determines whether there is a center line separating a target lane of the host vehicle 1a and an oncoming lane thereof on an entering destination roadway where the host vehicle 1a is about to enter by turning right or left (step S16).

On the other hand, if it is determined in step S14 that there is a center line on the roadway on which the host vehicle 1a is traveling (step S14: Yes), the control device 30 determines whether there is a center line on the entering destination roadway without displaying a division mark on the roadway on which the host vehicle 1a is traveling (step S16).

If it is determined in step S16 that there is no center line on the entering destination roadway of the host vehicle 1a (step S16: No), the control device 30 determines whether the host vehicle 1a is about to turn right (step S17).

If it is determined in step S17 that the host vehicle 1a is not about to turn right, that is, if the host vehicle 1a is about to turn left (step S17: No), the control device 30 determines whether an oncoming vehicle is detected in the oncoming lane of the target lane on the entering destination roadway where the host vehicle 1a is about to turn left to enter (step S18).

If it is determined in step S18 that there is an oncoming vehicle in the oncoming lane (step S18: Yes), the control device 30 starts processing of displaying, on the entering destination roadway, a division mark separating the target lane and the oncoming lane thereof (step S19).

On the other hand, if it is determined in step S17 that the host vehicle 1a is about to turn right (step S17: Yes), the control device 30 starts processing of displaying, on the entering destination roadway, a division mark separating the target lane and the oncoming lane thereof, regardless of whether an oncoming vehicle is detected on the entering destination roadway (step S19).

Next, the control device 30 starts processing of displaying guide lines connecting the center line and the division mark, the division mark and the division mark, and the center line and the center line (step S20). The guide line is an example of a "connection mark" of the present embodiment.

On the other hand, if it is determined in step S16 that there is a center line on the entering destination roadway of the host vehicle 1a (step S16: Yes), or if it is determined in step S18 that there is no oncoming vehicle in the oncoming lane (step S18: No), the control device 30 starts processing of displaying guide lines without displaying a division mark on the entering destination roadway (step S20). Here, if the division mark separating the target lane and the oncoming lane is not displayed on the entering destination roadway, the guide line may not be displayed. The peripheral image changes over time. Therefore, the control device 30 also updates the division mark and the guide line displayed superimposed on the peripheral image to follow the peripheral image.

Next, the control device 30 determines whether the right or left turn of the host vehicle 1a is completed (step S21). If it is determined in step S21 that the right or left turn is not completed (step S21: No), the control device 30 repeats the processing of step S21. If it is determined in step S21 that the right or left turn is completed (step S21: Yes), the control device 30 hides the division mark and the guide line superimposed on the peripheral image (step S22). In step S22, the control device 30 may also hide the peripheral image.

### 4. Information on Traveling Route

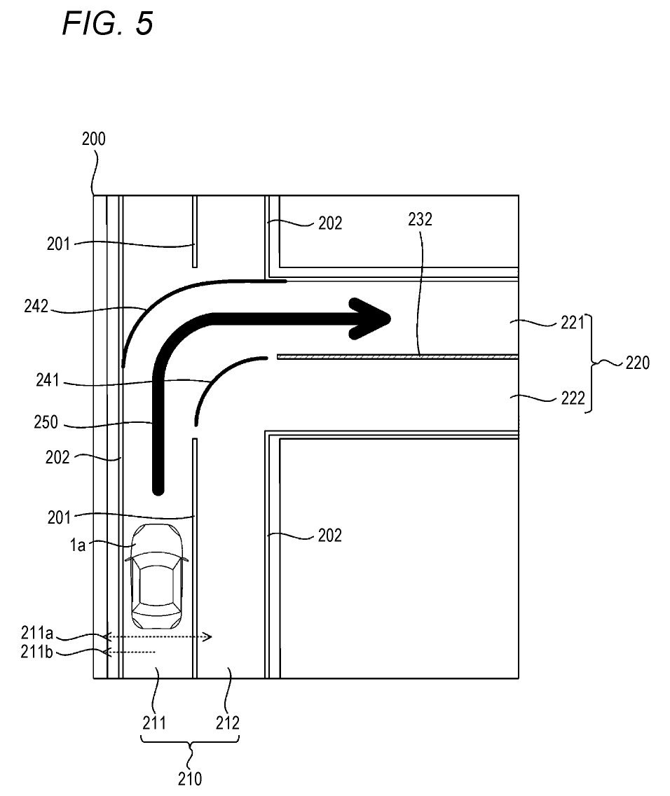

FIG. 5 is a diagram illustrating a first example of the information on the traveling route of the host vehicle 1a displayed on the peripheral image. As illustrated in FIG. 5, the peripheral image of the host vehicle 1a is displayed as, for example, a top view image 200. The top view image 200 is displayed on the touch panel 22 of the navigation device 20. Note that the host vehicle 1a displayed in the top view image 200 is an image showing a state where the host vehicle is viewed from above, and is a host vehicle image generated (imaged) in advance and stored in the storage unit 33 or the like.

In the peripheral image, a current roadway 210 on which the host vehicle 1a is currently traveling, and an entering destination roadway 220 which is a roadway that intersects the current roadway 210 in a T-junction shape and where the host vehicle 1a is about to enter, are displayed. The current roadway 210 includes a host lane 211 which is a travel lane of the host vehicle 1a, and an oncoming lane 212 of the host lane 211. The entering destination roadway 220 includes a target lane 221 which is an entering destination lane of the host vehicle 1a and an oncoming lane 222 of the target lane 221. A center line 201 separating the host lane 211 and the oncoming lane 212 thereof is provided on the current roadway 210. On the other hand, there is no center line separating the target lane 221 and the oncoming lane 222 thereof provided on the entering destination roadway 220. Outer lines 202 showing positions of outer sides of the roadways are displayed on the current roadway 210 and the entering destination roadway 220. The host vehicle 1a is about to turn right to enter the entering destination roadway 220 from the current roadway 210.

A lane width direction 211a is a direction of a lane width (horizontal width) of the host lane 211. In this example, since people drive on the left side of the road, the left direction in the lane width direction 211a is a first direction 211b when a traveling direction of the host vehicle 1a is a forward direction.

Based on the peripheral information of the host vehicle 1a, when the host vehicle 1a turns right from the host lane 211 in which the host vehicle 1a travels to enter the target lane 221 connected to the host lane 211, the display control unit 32 of the host vehicle 1a displays a route image 250 guiding the host vehicle 1a from the host lane 211 to the target lane 221.

When the oncoming lane 222 of the target lane 221 exists on the entering destination roadway 220 including the target lane 221, and a center line separating the target lane 221 and the oncoming lane 222 thereof does not exist or is not detected, the display control unit 32 displays a division mark 232 separating the target lane 221 and the oncoming lane 222 thereof in the display of the route from the host lane 211 to the target lane 221.

The display control unit 32 displays a guide line 241 connecting the center line 201 separating the host lane 211 and the oncoming lane 212 thereof and the division mark 232 separating the target lane 221 and the oncoming lane 222 thereof. The guide line 241 is a guide line showing a right edge of a travel lane that continues from the host lane 211 to the target lane 221. The display control unit 32 also displays a guide line 242 showing a left edge of the travel lane that continues from the host lane 211 to the target lane 221, the left edge being opposite to the guide line 241. The guide line 242 is a guide line that connects the outer line 202 of the current roadway 210 and the outer line 202 of the entering destination roadway 220.

Although the description is given using a top view image as an example in FIG. 5, the peripheral image may be similarly displayed as, for example, a front view image or a 3D image. Although the route image 250 is an arrow in FIG. 5, the present invention is not limited thereto. The route image may be, for example, a display in which the entire traveling route with arrows displayed is colored.

In this way, when the host vehicle 1a turns right to enter the entering destination roadway 220 from the current roadway 210, in the display of the route image 250 from the host lane 211 of the current roadway 210 to the target lane 221 of the entering destination roadway 220, if the center line 201 separating the host lane 211 and the oncoming lane 212 exists and there is no division line separating the target lane 221 and the oncoming lane 222, the control device 30 displays the division mark 232 separating the target lane 221 and the oncoming lane 222, and displays the guide line 241 connecting the displayed division mark 232 and the center line 201, and the guide line 242 showing the opposite edge. According to this configuration, when the host vehicle 1a turns right to enter a roadway where there is no division line separating the target lane and the oncoming lane, the host vehicle 1a can be caused to travel along the displayed route image 250, the division mark 232, and the guide lines 241 and 242, thereby enabling appropriate route display and improving ease of driving operations. In this way, it is possible to prevent the host vehicle 1a from taking a shortcut on the roadway when entering the target lane 221, for example.

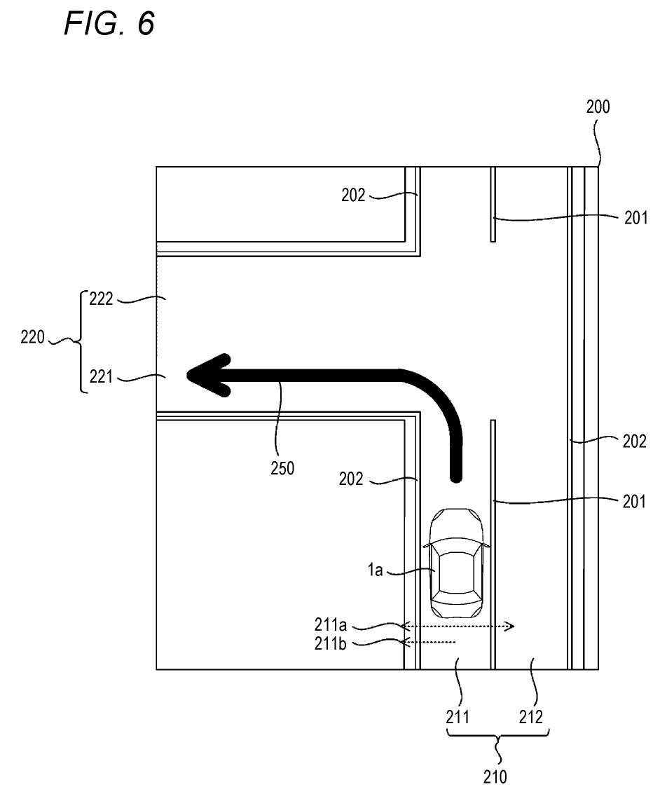

FIG. 6 is a diagram illustrating a second example of the information on the traveling route of the host vehicle 1a displayed on the peripheral image. As illustrated in FIG. 6, in the peripheral image, a current roadway 210 on which the host vehicle 1a is currently traveling, and an entering destination roadway 220 which is a roadway that intersects the current roadway 210 in a T-junction shape and where the host vehicle 1a is about to enter, are displayed. The current roadway 210 includes a host lane 211 which is a travel lane of the host vehicle 1a, and an oncoming lane 212 of the host lane 211. The entering destination roadway 220 includes a target lane 221 which is an entering destination lane of the host vehicle 1a and an oncoming lane 222 of the target lane 221. A center line 201 separating the host lane 211 and the oncoming lane 212 is provided on the current roadway 210. On the other hand, there is no center line separating the target lane 221 and the oncoming lane 222 provided on the entering destination roadway 220. In addition, there is no oncoming vehicle in the oncoming lane 222 of the target lane 221. Outer lines 202 showing positions of outer sides of the roadways are displayed on the current roadway 210 and the entering destination roadway 220. The host vehicle 1a is about to turn left to enter the entering destination roadway 220 from the current roadway 210.

Based on the peripheral information of the host vehicle 1a, when the host vehicle 1a turns left from the host lane 211 in which the host vehicle 1a travels to enter the target lane 221 connected to the host lane 211, the display control unit 32 of the host vehicle 1a displays a route image 250 guiding the host vehicle 1a from the host lane 211 to the target lane 221.

Note that when the oncoming lane 222 of the target lane 221 exists on the entering destination roadway 220 including the target lane 221, and a center line separating the target lane 221 and the oncoming lane 222 thereof does not exist or is not detected, and when the host vehicle 1a turns left to enter the target lane 221, the display control unit 32 does not display the division mark separating the target lane 221 and the oncoming lane 222 thereof in the display of the route from the host lane 211 to the target lane 221 if there is no oncoming vehicle in the oncoming lane 222 of the target lane 221.

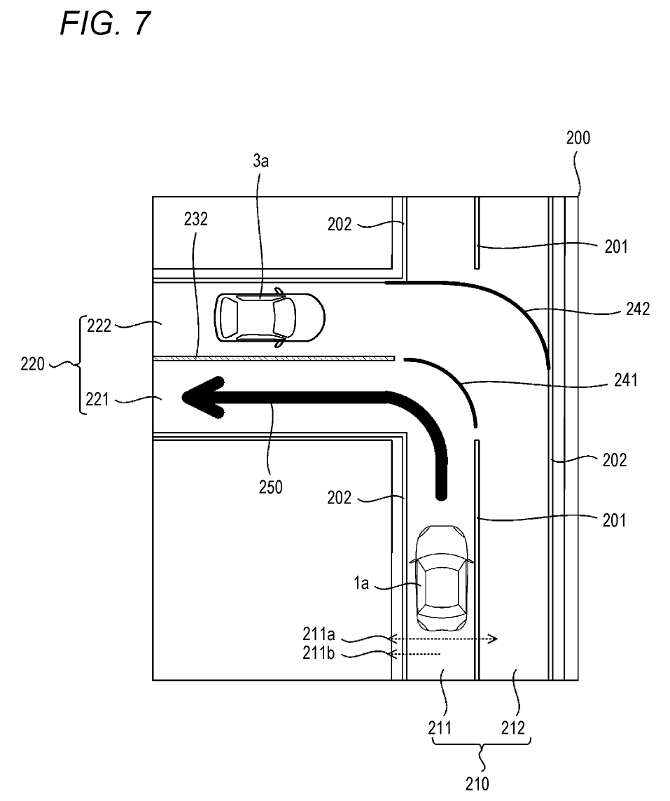

FIG. 7 is a diagram illustrating a third example of the information on the traveling route of the host vehicle 1a displayed on the peripheral image. As illustrated in FIG. 7, in the peripheral image, similar to the peripheral image of the second example illustrated in FIG. 6, a current roadway 210 including a host lane 211 and an oncoming lane 212, and an entering destination roadway 220 including the target lane 221 and the oncoming lane 222 are displayed. The current roadway 210 and the entering destination roadway 220 intersect to form a T-junction shape. A center line 201 is provided on the current roadway 210, and no center line is provided on the entering destination roadway 220. Outer lines 202 are displayed on the current roadway 210 and the entering destination roadway 220. The host vehicle 1a is about to turn left to enter the entering destination roadway 220 from the current roadway 210. However, in this third example, there is an oncoming vehicle 3a in the oncoming lane 222 of the target lane 221.

Based on the peripheral information of the host vehicle 1a, when the host vehicle 1a turns left from the host lane 211 in which the host vehicle 1a travels to enter the target lane 221 connected to the host lane 211, the display control unit 32 of the host vehicle 1a displays a route image 250 guiding the host vehicle 1a from the host lane 211 to the target lane 221.

When the oncoming lane 222 of the target lane 221 exists on the entering destination roadway 220 including the target lane 221, and a center line separating the target lane 221 and the oncoming lane 222 thereof does not exist or is not detected, and when the host vehicle 1a turns left to enter the target lane 221, the display control unit 32 displays a division mark 232 separating the target lane 221 and the oncoming lane 222 thereof in the display of the route from the host lane 211 to the target lane 221 since the oncoming vehicle 3a exists in the oncoming lane 222 of the target lane 221.

The display control unit 32 displays a guide line 241 connecting the center line 201 separating the host lane 211 and the oncoming lane 212 thereof and the division mark 232 separating the target lane 221 and the oncoming lane 222 thereof. The guide line 241 is a guide line showing a right edge of a travel lane that continues from the host lane 211 to the target lane 221. The display control unit 32 may also display a guide line 242 showing a right edge of a travel lane that continues from the oncoming lane 212 of the host lane 211 to the oncoming lane 222 of the target lane 221. The guide line 242 is a guide line that connects the outer line 202 of the current roadway 210 and the outer line 202 of the entering destination roadway 220.

Note that the oncoming vehicle 3a detected in the oncoming lane 222 of the target lane 221 may not be displayed as an image (for example, in a case of a CG image based on map data).

In this way, when the host vehicle 1a turns left to enter the entering destination roadway 220 from the current roadway 210, in the display of the route image 250 from the host lane 211 of the current roadway 210 to the target lane 221 of the entering destination roadway 220, if the center line 201 separating the host lane 211 and the oncoming lane 212 exists and there is no division line separating the target lane 221 and the oncoming lane 222, the control device 30 displays the division mark 232 separating the target lane 221 and the oncoming lane 222, and displays the guide line 241 connecting the displayed division mark 232 and the center line 201 on condition that the oncoming vehicle 3a exists in the oncoming lane 222 of the target lane 221. According to this configuration, when the host vehicle 1a turns left to enter a roadway where there is no division line separating the target lane and the oncoming lane, the host vehicle 1a can be caused to travel along the displayed route image 250, the division mark 232, and the guide line 241 if the oncoming vehicle 3a exists in the entering destination roadway 220, thereby enabling appropriate route display and improving the ease of driving operations. If the oncoming vehicle 3a does not exist on the entering destination roadway 220, the host vehicle 1a can simply be caused to travel along the displayed route image 250 with no division mark and guide line displayed. Therefore, no unnecessary display other than the route image 250 is performed, and the ease of driving operations can be improved.

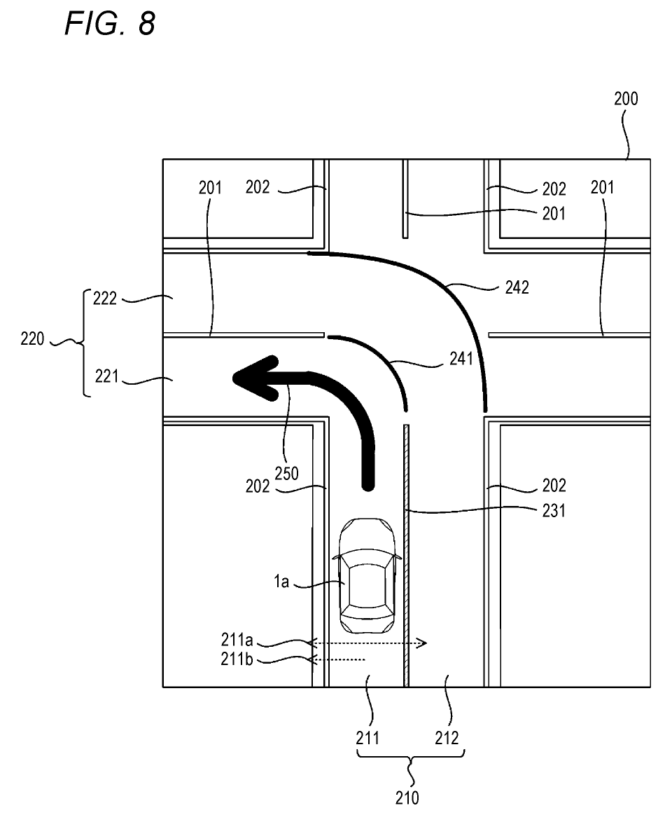

FIG. 8 is a diagram illustrating a fourth example of the information on the traveling route of the host vehicle 1a displayed on the peripheral image. As illustrated in FIG. 8, in the peripheral image, a current roadway 210 on which the host vehicle 1a is currently traveling, and an entering destination roadway 220 which is a roadway that intersects the current roadway 210 in a crossway shape and where the host vehicle 1a is about to enter, are displayed. The current roadway 210 includes a host lane 211 which is a travel lane of the host vehicle 1a, and an oncoming lane 212 of the host lane 211. The entering destination roadway 220 includes a target lane 221 which is an entering destination lane of the host vehicle 1a and an oncoming lane 222 of the target lane 221. A center line 201 separating the target lane 221 and the oncoming lane 222 thereof is provided on the entering destination roadway 220. On the other hand, no center line separating the host lane 211 and the oncoming lane 212 thereof is provided on the current roadway 210. Outer lines 202 showing positions of outer sides of the roadways are displayed on the current roadway 210 and the entering destination roadway 220. The host vehicle 1a is about to turn left to enter the entering destination roadway 220 from the current roadway 210.

Based on the peripheral information of the host vehicle 1a, when the host vehicle 1a turns left from the host lane 211 in which the host vehicle 1a travels to enter the target lane 221 connected to the host lane 211, the display control unit 32 of the host vehicle 1a displays a route image 250 guiding the host vehicle 1a from the host lane 211 to the target lane 221.

When the oncoming lane 212 of the host lane 211 exists on the current roadway 210 including the host lane 211, and a center line separating the host lane 211 and the oncoming lane 212 thereof does not exist or is not detected, the display control unit 32 displays a division mark 231 separating the host lane 211 and the oncoming lane 212 in the display of the route from the host lane 211 to the target lane 221.

The display control unit 32 displays a guide line 241 connecting the division mark 231 displayed for separating the host lane 211 and the oncoming lane 212 thereof and the center line 201 separating the target lane 221 and the oncoming lane 222 thereof. The guide line 241 is a guide line showing a right edge of a travel lane that continues from the host lane 211 to the target lane 221. The display control unit 32 may also display a guide line 242 showing a right edge of a travel lane that continues from the oncoming lane 212 of the host lane 211 to the oncoming lane 222 of the target lane 221. The guide line 242 is a guide line that connects the outer line 202 of the current roadway 210 and the outer line 202 of the entering destination roadway 220.

In this way, when the host vehicle 1a turns left to enter the entering destination roadway 220 from the current roadway 210, in the display of the route image 250 from the host lane 211 of the current roadway 210 to the target lane 221 of the entering destination roadway 220, if there is no division line separating the host lane 211 and the oncoming lane 212 and the center line 201 separating the target lane 221 and the oncoming lane 222 exists, the control device 30 displays the division mark 231 separating the host lane 211 and the oncoming lane 212, and displays a guide line 241 connecting the displayed division mark 231 and the center line 201. According to this configuration, when the host vehicle 1a turns left to enter the entering destination roadway 220 from the current roadway 210 with no division line, the host vehicle 1a can be caused to travel along the displayed route image 250, the division mark 231, and the guide line 241, thereby enabling appropriate route display and improving ease of driving operations. In this way, it is possible to prevent the host vehicle 1a from making a wide left turn while swerving into the oncoming lane 212 when entering the target lane 221, for example.

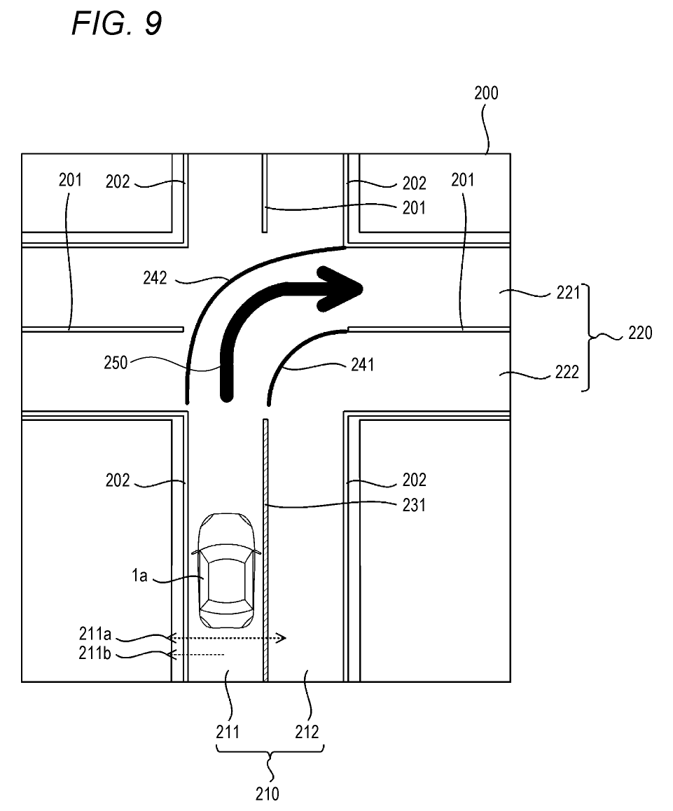

FIG. 9 is a diagram illustrating a fifth example of the information on the traveling route of the host vehicle 1a displayed on the peripheral image. As illustrated in FIG. 9, in the peripheral image, similar to the peripheral image of the fourth example illustrated in FIG. 8, a current roadway 210 including a host lane 211 and an oncoming lane 212, and an entering destination roadway 220 including the target lane 221 and the oncoming lane 222 are displayed. The current roadway 210 and the entering destination roadway 220 intersect to form a crossway shape. A center line 201 is provided on the entering destination roadway 220, and no center line is provided on the current roadway 210. Outer lines 202 are displayed on the current roadway 210 and the entering destination roadway 220. However, in the fifth example, the host vehicle 1a is about to turn right to enter the entering destination roadway 220 from the current roadway 210.

Based on the peripheral information of the host vehicle 1a, when the host vehicle 1a turns right from the host lane 211 in which the host vehicle 1a travels to enter the target lane 221 connected to the host lane 211, the display control unit 32 of the host vehicle 1a displays a route image 250 guiding the host vehicle 1a from the host lane 211 to the target lane 221.

When the oncoming lane 212 of the host lane 211 exists on the current roadway 210 including the host lane 211, and a center line separating the host lane 211 and the oncoming lane 212 thereof does not exist or is not detected, the display control unit 32 displays a division mark 231 separating the host lane 211 and the oncoming lane 212 in the display of the route from the host lane 211 to the target lane 221.

The display control unit 32 displays a guide line 241 connecting the division mark 231 displayed for separating the host lane 211 and the oncoming lane 212 thereof and the center line 201 separating the target lane 221 and the oncoming lane 222 thereof. The guide line 241 is a guide line showing a right edge of a travel lane that continues from the host lane 211 to the target lane 221. The display control unit 32 also displays a guide line 242 showing a left edge of the travel lane that continues from the host lane 211 to the target lane 221, the left edge being opposite to the guide line 241. The guide line 242 is a guide line that connects the outer line 202 of the current roadway 210 and the outer line 202 of the entering destination roadway 220.

In this way, when the host vehicle 1a turns right to enter the entering destination roadway 220 from the current roadway 210, in the display of the route image 250 from the host lane 211 of the current roadway 210 to the target lane 221 of the entering destination roadway 220, if there is no division line separating the host lane 211 and the oncoming lane 212 and the center line 201 separating the target lane 221 and the oncoming lane 222 exists, the control device 30 displays the division mark 231 separating the host lane 211 and the oncoming lane 212, and displays the guide line 241 connecting the displayed division mark 231 and the center line 201, and the guide line 242 showing the opposite edge. According to this configuration, when the host vehicle 1a turns right to enter the entering destination roadway 220 from the current roadway 210 with no division line, the host vehicle 1a can be caused to travel along the displayed route image 250, the division mark 231, and the guide lines 241 and 242, thereby enabling appropriate route display and improving ease of driving operations. In this way, it is possible to prevent the host vehicle 1a from taking a shortcut on the roadway when entering the target lane 221, for example.

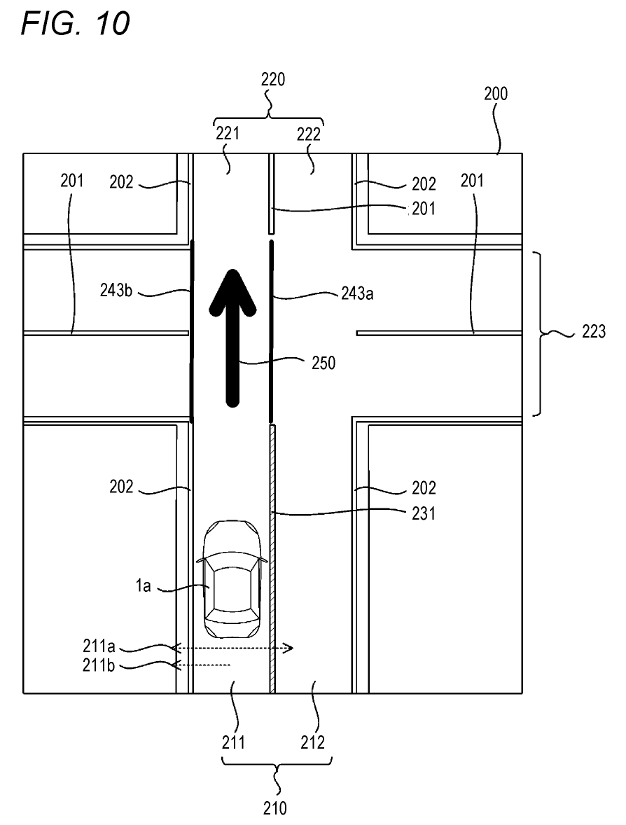

FIG. 10 is a diagram illustrating a sixth example of the information on the traveling route of the host vehicle 1a displayed on the peripheral image. As illustrated in FIG. 10, in the peripheral image, a current roadway 210 on which the host vehicle 1a is currently traveling, and an entering destination roadway 220 which is a roadway extending beyond the current roadway 210 and where the host vehicle 1a is about to enter, are displayed. A roadway 223 intersects the current roadway 210 and the entering destination roadway 220 to form a crossway shape. The current roadway 210 includes a host lane 211 which is a travel lane of the host vehicle 1a, and an oncoming lane 212 of the host lane 211. The entering destination roadway 220 includes a target lane 221 which is an entering destination lane of the host vehicle 1a and an oncoming lane 222 of the target lane 221. A center line 201 is provided on the entering destination roadway 220. On the other hand, no center line is provided on the current roadway 210. Outer lines 202 are displayed on the current roadway 210 and the entering destination roadway 220. The host vehicle 1a is about to go straight on an intersection from the current roadway 210 to enter the entering destination roadway 220.

Based on the peripheral information of the host vehicle 1a, when the host vehicle 1a goes straight from the host lane 211 in which the host vehicle 1a travels to enter the target lane 221 connected to the host lane 211, the display control unit 32 of the host vehicle 1a displays a route image 250 guiding the host vehicle 1a from the host lane 211 to the target lane 221.

When the oncoming lane 212 of the host lane 211 exists on the current roadway 210 including the host lane 211, and a center line separating the host lane 211 and the oncoming lane 212 thereof does not exist or is not detected, the display control unit 32 displays a division mark 231 separating the host lane 211 and the oncoming lane 212 in the display of the route from the host lane 211 to the target lane 221.

The display control unit 32 displays a guide line 243a connecting the division mark 231 displayed for separating the host lane 211 and the oncoming lane 212 thereof and the center line 201 separating the target lane 221 and the oncoming lane 222 thereof. The guide line 243a is a guide line showing a right edge of a travel lane that continues from the host lane 211 to the target lane 221. The display control unit 32 also displays a guide line 243b showing a left edge of the travel lane that continues from the host lane 211 to the target lane 221, the left edge being opposite to the guide line 243a. The guide line 243b is a guide line that connects the outer line 202 of the current roadway 210 and the outer line 202 of the entering destination roadway 220.

In this way, when the host vehicle 1a goes straight to enter the entering destination roadway 220 from the current roadway 210, in the display of the route image 250 from the host lane 211 of the current roadway 210 to the target lane 221 of the entering destination roadway 220, if there is no division line separating the host lane 211 and the oncoming lane 212 and the center line 201 separating the target lane 221 and the oncoming lane 222 exists, the control device 30 displays the division mark 231 separating the host lane 211 and the oncoming lane 212, and displays the guide line 243a connecting the displayed division mark 231 and the center line 201, and the guide line 243b showing the opposite edge. According to this configuration, when the host vehicle 1a goes straight to enter the entering destination roadway 220 from the current roadway 210 with no division line, the host vehicle 1a can be caused to travel along the displayed route image 250, the division mark 231, and the guide lines 243a and 243b, thereby enabling appropriate route display and improving ease of driving operations.

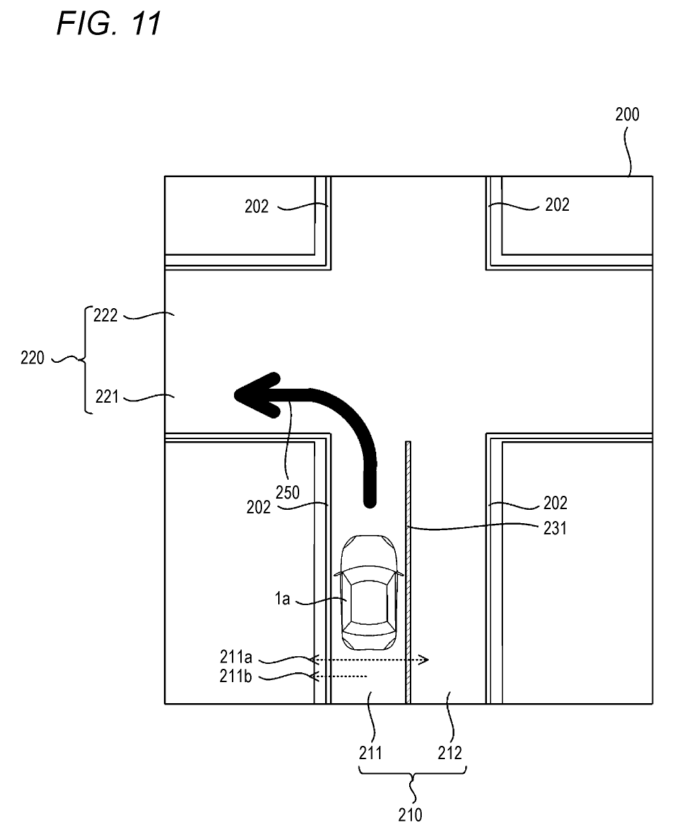

FIG. 11 is a diagram illustrating a seventh example of the information on the traveling route of the host vehicle 1a displayed on the peripheral image. As illustrated in FIG. 11, in the peripheral image, a current roadway 210 on which the host vehicle 1a is currently traveling, and an entering destination roadway 220 which is a roadway that intersects the current roadway 210 in a crossway shape and where the host vehicle 1a is about to enter, are displayed. The current roadway 210 includes a host lane 211 which is a travel lane of the host vehicle 1a, and an oncoming lane 212 of the host lane 211. The entering destination roadway 220 includes a target lane 221 which is an entering destination lane of the host vehicle 1a and an oncoming lane 222 of the target lane 221. No center line separating the host lane 211 and the oncoming lane 212 is provided on the current roadway 210. Similarly, there is no center line separating the target lane 221 and the oncoming lane 222 provided on the entering destination roadway 220. In addition, there is no oncoming vehicle in the oncoming lane 222 of the target lane 221. Outer lines 202 showing positions of outer sides of the roadways are displayed on the current roadway 210 and the entering destination roadway 220. The host vehicle 1a is about to turn left to enter the entering destination roadway 220 from the current roadway 210.

Based on the peripheral information of the host vehicle 1a, when the host vehicle 1a turns left from the host lane 211 in which the host vehicle 1a travels to enter the target lane 221 connected to the host lane 211, the display control unit 32 of the host vehicle 1a displays a route image 250 guiding the host vehicle 1a from the host lane 211 to the target lane 221.

When the oncoming lane 212 of the host lane 211 exists on the current roadway 210 including the host lane 211, and a center line separating the host lane 211 and the oncoming lane 212 thereof does not exist or is not detected, the display control unit 32 displays a division mark 231 separating the host lane 211 and the oncoming lane 212 thereof in the display of the route from the host lane 211 to the target lane 221.

Note that when the oncoming lane 222 of the target lane 221 exists on the entering destination roadway 220 including the target lane 221, and a center line separating the target lane 221 and the oncoming lane 222 thereof does not exist or is not detected, and when the host vehicle 1a turns left to enter the target lane 221, the display control unit 32 does not display the division mark separating the target lane 221 and the oncoming lane 222 thereof in the display of the route from the host lane 211 to the target lane 221 if there is no oncoming vehicle in the oncoming lane 222 of the target lane 221.

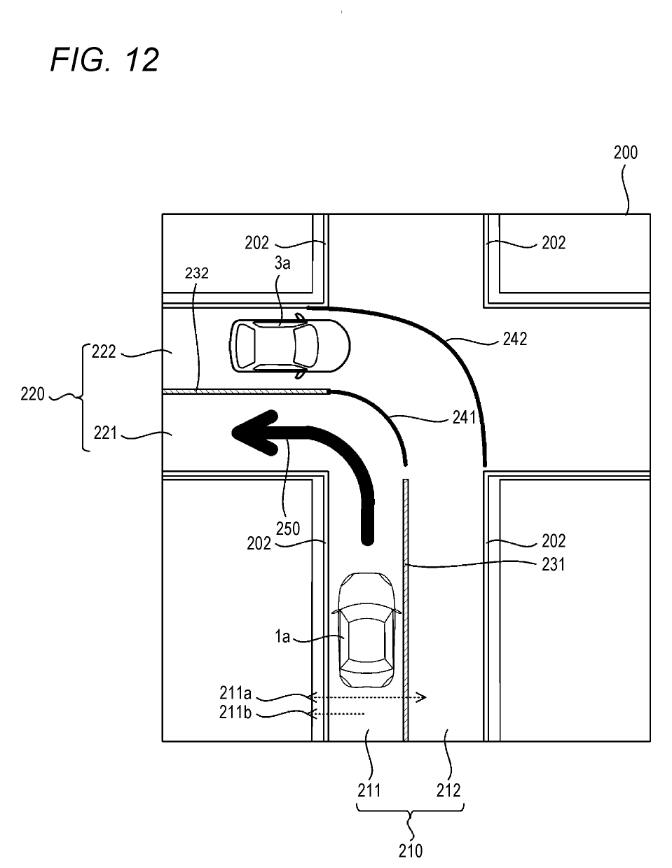

FIG. 12 is a diagram illustrating an eighth example of the information on the traveling route of the host vehicle 1a displayed on the peripheral image. As illustrated in FIG. 12, in the peripheral image, similar to the peripheral image of the seventh example illustrated in FIG. 11, a current roadway 210 including a host lane 211 and an oncoming lane 212, and an entering destination roadway 220 including the target lane 221 and the oncoming lane 222 are displayed. The current roadway 210 and the entering destination roadway 220 intersect to form a crossway shape. There is no center line provided on either the current roadway 210 or the entering destination roadway 220. Outer lines 202 are displayed on the current roadway 210 and the entering destination roadway 220. The host vehicle 1a is about to turn left to enter the entering destination roadway 220 from the current roadway 210. However, in this eighth example, there is an oncoming vehicle 3a in the oncoming lane 222 of the target lane 221.

Based on the peripheral information of the host vehicle 1a, when the host vehicle 1a turns left from the host lane 211 in which the host vehicle 1a travels to enter the target lane 221 connected to the host lane 211, the display control unit 32 of the host vehicle 1a displays a route image 250 guiding the host vehicle 1a from the host lane 211 to the target lane 221.

When the oncoming lane 222 of the target lane 221 exists on the entering destination roadway 220 including the target lane 221, and a center line separating the target lane 221 and the oncoming lane 222 thereof does not exist or is not detected, when the oncoming lane 212 of the host lane 211 exists on the current roadway 210 including the host lane 211, and a center line separating the host lane 211 and the oncoming lane 212 thereof does not exist or is not detected, and when the host vehicle 1a turns left from the host lane 211 to enter the target lane 221, the display control unit 32 displays, in the display of the route from the host lane 211 to the target lane 221, a division mark 231 separating the host lane 211 and the oncoming lane 212 thereof, and displays a division mark 232 separating the target lane 221 and the oncoming lane 222 thereof since the oncoming vehicle 3a exists in the oncoming lane 222 of the target lane 221. The division mark 231 is an example of a "first division mark" of the present embodiment. The division mark 232 is an example of a "second division mark" of the present embodiment.

The display control unit 32 displays a guide line 241 connecting the division mark 231 displayed for separating the host lane 211 and the oncoming lane 212 thereof and the division mark 232 displayed for separating the target lane 221 and the oncoming lane 222 thereof. The guide line 241 is a guide line showing a right edge of a travel lane that continues from the host lane 211 to the target lane 221. The display control unit 32 may also display a guide line 242 showing a right edge of a travel lane that continues from the oncoming lane 212 of the host lane 211 to the oncoming lane 222 of the target lane 221. The guide line 242 is a guide line that connects the outer line 202 of the current roadway 210 and the outer line 202 of the entering destination roadway 220.

In this way, when the host vehicle 1a turns left to enter the entering destination roadway 220 from the current roadway 210, in the display of the route image 250 from the host lane 211 of the current roadway 210 to the target lane 221 of the entering destination roadway 220, if there is no division line separating the host lane 211 and the oncoming lane 212 and there is also no division line separating the target lane 221 and the oncoming lane 222, the control device 30 displays the division mark 231 separating the host lane 211 and the oncoming lane 212, and the division mark 232 separating the target lane 221 and the oncoming lane 222, and displays the guide line 241 connecting the displayed division mark 231 and the division mark 232 on condition that the oncoming vehicle 3a exists in the oncoming lane 222 of the target lane 221. According to this configuration, when the host vehicle 1a turns left to enter the entering destination roadway 220 with no division line from the current roadway 210 with no division line, the host vehicle 1a can be caused to travel along the displayed route image 250, the division marks 231 and 232, and the guide line 241 if the oncoming vehicle 3a exists in the entering destination roadway 220, thereby enabling appropriate route display and improving the ease of driving operations. If the oncoming vehicle 3a does not exist on the entering destination roadway 220, the host vehicle 1a can simply be caused to travel along the displayed route image 250 with no division mark and guide line displayed on the entering destination roadway 220. Therefore, no unnecessary display other than the route image 250 is performed, and the ease of driving operations can be improved.

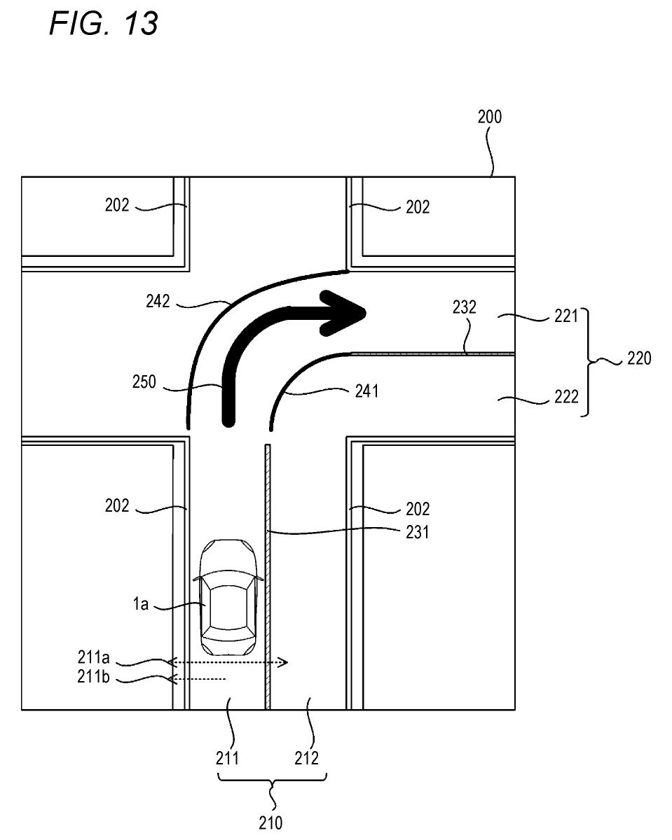

FIG. 13 is a diagram illustrating a ninth example of the information on the traveling route of the host vehicle 1a displayed on the peripheral image. As illustrated in FIG. 13, in the peripheral image, similar to the peripheral image of the seventh example illustrated in FIG. 11, a current roadway 210 including a host lane 211 and an oncoming lane 212, and an entering destination roadway 220 including the target lane 221 and the oncoming lane 222 are displayed. The current roadway 210 and the entering destination roadway 220 intersect to form a crossway shape. There is no center line provided on either the current roadway 210 or the entering destination roadway 220. Outer lines 202 are displayed on the current roadway 210 and the entering destination roadway 220. However, in the ninth example, the host vehicle 1a is about to turn right to enter the entering destination roadway 220 from the current roadway 210.

Based on the peripheral information of the host vehicle 1a, when the host vehicle 1a turns right from the host lane 211 in which the host vehicle 1a travels to enter the target lane 221 connected to the host lane 211, the display control unit 32 of the host vehicle 1a displays a route image 250 guiding the host vehicle 1a from the host lane 211 to the target lane 221.

When the oncoming lane 222 of the target lane 221 exists on the entering destination roadway 220 including the target lane 221, and a center line separating the target lane 221 and the oncoming lane 222 thereof does not exist or is not detected, when the oncoming lane 212 of the host lane 211 exists on the current roadway 210 including the host lane 211, and a center line separating the host lane 211 and the oncoming lane 212 thereof does not exist or is not detected, and when the host vehicle 1a turns right from the host lane 211 to enter the target lane 221, the display control unit 32 displays, in the display of the route from the host lane 211 to the target lane 221, a division mark 231 separating the host lane 211 and the oncoming lane 212 thereof, and displays a division mark 232 separating the target lane 221 and the oncoming lane 222 thereof. The division mark 231 is an example of a "first division mark" of the present embodiment. The division mark 232 is an example of a "second division mark" of the present embodiment.

The display control unit 32 displays a guide line 241 connecting the division mark 231 displayed for separating the host lane 211 and the oncoming lane 212 thereof and the division mark 232 displayed for separating the target lane 221 and the oncoming lane 222 thereof. The guide line 241 is a guide line showing a right edge of a travel lane that continues from the host lane 211 to the target lane 221. The display control unit 32 also displays a guide line 242 showing a left edge of the travel lane that continues from the host lane 211 to the target lane 221, the left edge being opposite to the guide line 241. The guide line 242 is a guide line that connects the outer line 202 of the current roadway 210 and the outer line 202 of the entering destination roadway 220.

In this way, when the host vehicle 1a turns right to enter the entering destination roadway 220 from the current roadway 210, in the display of the route image 250 from the host lane 211 of the current roadway 210 to the target lane 221 of the entering destination roadway 220, if there is no division line separating the host lane 211 and the oncoming lane 212 and there is also no division line separating the target lane 221 and the oncoming lane 222, the control device 30 displays the division mark 231 separating the host lane 211 and the oncoming lane 212, and the division mark 232 separating the target lane 221 and the oncoming lane 222, and displays the guide line 241 connecting the displayed division mark 231 and the division mark 232, and the guide line 242 showing the opposite edge thereof. According to this configuration, when the host vehicle 1a turns right to enter the entering destination roadway 220 with no division line from the current roadway 210 with no division line, the host vehicle 1a can be caused to travel along the displayed route image 250, the division marks 231 and 232, and the guide lines 241 and 242, thereby enabling appropriate route display and improving ease of driving operations. In this way, it is possible to prevent the host vehicle 1a from taking a shortcut on the roadway when entering the target lane 221, for example.

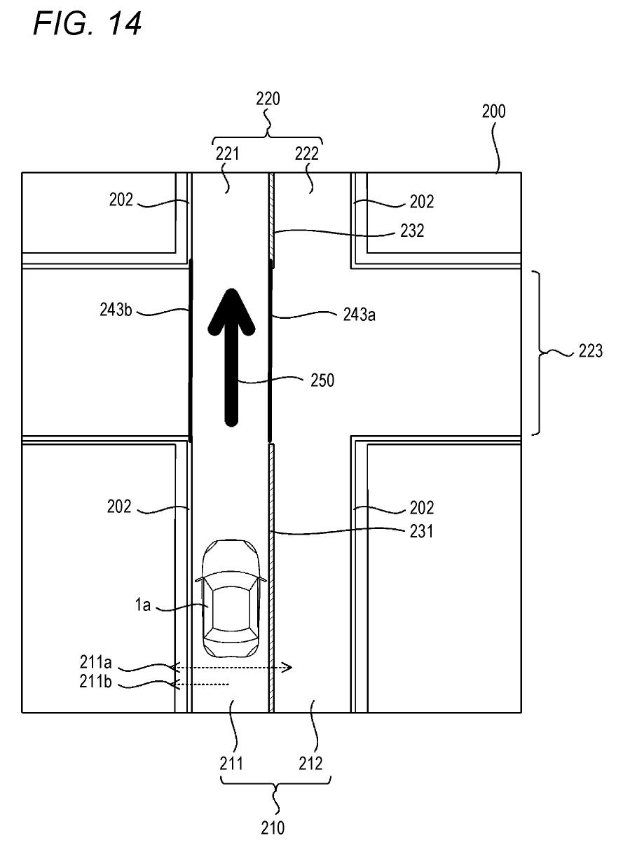

FIG. 14 is a diagram illustrating a tenth example of the information on the traveling route of the host vehicle 1a displayed on the peripheral image. As illustrated in FIG. 14, in the peripheral image, a current roadway 210 on which the host vehicle 1a is currently traveling, and an entering destination roadway 220 which is a roadway extending beyond the current roadway 210 and where the host vehicle 1a is about to enter, are displayed. A roadway 223 intersects the current roadway 210 and the entering destination roadway 220 to form a crossway shape. The current roadway 210 includes a host lane 211 which is a travel lane of the host vehicle 1a, and an oncoming lane 212 of the host lane 211. The entering destination roadway 220 includes a target lane 221 which is an entering destination lane of the host vehicle 1a and an oncoming lane 222 of the target lane 221. No center line is provided on either the current roadway 210 or the entering destination roadway 220. Outer lines 202 are displayed on the current roadway 210 and the entering destination roadway 220. The host vehicle 1a is about to go straight on an intersection from the current roadway 210 to enter the entering destination roadway 220.

Based on the peripheral information of the host vehicle 1a, when the host vehicle 1a goes straight from the host lane 211 in which the host vehicle 1a travels to enter the target lane 221 connected to the host lane 211, the display control unit 32 of the host vehicle 1a displays a route image 250 guiding the host vehicle 1a from the host lane 211 to the target lane 221.

When the oncoming lane 222 of the target lane 221 exists on the entering destination roadway 220 including the target lane 221, and a center line separating the target lane 221 and the oncoming lane 222 thereof does not exist or is not detected, when the oncoming lane 212 of the host lane 211 exists on the current roadway 210 including the host lane 211, and a center line separating the host lane 211 and the oncoming lane 212 thereof does not exist or is not detected, and when the host vehicle 1a goes straight to enter the target lane 221 from the host lane 211, the display control unit 32 displays, in the display of the route from the host lane 211 to the target lane 221, a division mark 231 separating the host lane 211 and the oncoming lane 212 thereof, and displays a division mark 232 separating the target lane 221 and the oncoming lane 222 thereof. The division mark 231 is an example of a "first division mark" of the present embodiment. The division mark 232 is an example of a "second division mark" of the present embodiment.

The display control unit 32 displays a guide line 243a connecting the division mark 231 displayed for separating the host lane 211 and the oncoming lane 212 thereof and the division mark 232 displayed for separating the target lane 221 and the oncoming lane 222 thereof. The guide line 243a is a guide line showing a right edge of a travel lane that continues from the host lane 211 to the target lane 221. The display control unit 32 also displays a guide line 243b showing a left edge of the travel lane that continues from the host lane 211 to the target lane 221, the left edge being opposite to the guide line 243a. The guide line 243b is a guide line that connects the outer line 202 of the current roadway 210 and the outer line 202 of the entering destination roadway 220.

In this way, when the host vehicle 1a goes straight to enter the entering destination roadway 220 from the current roadway 210, in the display of the route image 250 from the host lane 211 of the current roadway 210 to the target lane 221 of the entering destination roadway 220, if there is no division line separating the host lane 211 and the oncoming lane 212 and there is also no division line separating the target lane 221 and the oncoming lane 222, the control device 30 displays the division mark 231 separating the host lane 211 and the oncoming lane 212, and the division mark 232 separating the target lane 221 and the oncoming lane 222, and displays the guide line 243a connecting the displayed division mark 231 and the division mark 232, and the guide line 243b showing the opposite edge thereof. According to this configuration, when the host vehicle 1a goes straight to enter the entering destination roadway 220 with no division line from the current roadway 210 with no division line, the host vehicle 1a can be caused to travel along the displayed route image 250, the division marks 231 and 232, and the guide lines 243a and 243b, thereby enabling appropriate route display and improving ease of driving operations.

Although various embodiments have been described above with reference to the drawings, it is needless to say that the present invention is not limited to these examples. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

The control method described in the above embodiment may be implemented by executing a program (control program) prepared in advance on a computer. For example, the present program is stored in a computer-readable storage medium and executed by being read from the storage medium. In addition, the present program may be provided in a form of being stored in a nonvolatile (non-transitory) storage medium such as a flash memory, or may be provided via a network such as the Internet.

In the embodiment described above, the computer that executes the program is the control device 30 provided in the vehicle 1, but the present invention is not limited thereto. For example, the computer that executes the present program may be provided in another device (for example, the external device 2) capable of communicating with the control device 30.

In the embodiment described above, a case where the display control unit 32 displays the top view image and the like on the touch panel 22 of the vehicle 1 has been described, but the present invention is not limited thereto. For example, the display control unit 32 may display the top view image and the like on another display unit such as the MID 91. The display control unit 32 may display the top view image and the like on a display screen of an information terminal (for example, a smartphone) carried by a passenger of the vehicle 1 via the communication unit 70.

In the present specification, at least the following matters are described. In the parentheses, the corresponding constituent elements and the like in the above embodiment are shown as examples, but the present invention is not limited thereto.

(1) A control device (control device 30), including:

a processor (acquisition unit 31, display control unit 32) configured to

acquire peripheral information of a host vehicle (host vehicle 1a), and

display, when the host vehicle turns right or left from a host lane (host lane 211) in which the host vehicle travels to enter a target lane (target lane 221) connected to the host lane, a route from the host lane to the target lane (route image 250) to an occupant of the host vehicle based on the peripheral information, in which

when an oncoming lane (oncoming lane 222) of the target lane exists on a roadway (destination roadway 220) including the target lane and a division line (center line 201) separating the target lane and the oncoming lane of the target lane does not exist or is not detected, the processor displays a division mark (division mark 232) separating the target lane and the oncoming lane of the target lane in display of the route.

According to (1), when the host vehicle enters the target lane by turning right or left, if there is no division line separating the target lane and the oncoming lane thereof, by displaying a division mark separating those lanes, it is possible to appropriately display a right or left turn, thereby improving ease of driving operations.

(2) The control device according to (1), in which

the host vehicle travels on a first direction (first direction 211b) side of a road, and

when the oncoming lane of the target lane exists, and the division line separating the target lane and the oncoming lane of the target lane does not exist or is not detected, and when the host vehicle turns in the first direction and enters the target lane, the processor displays the division mark separating the target lane and the oncoming lane of the target lane in the display of the route in response to presence of an oncoming vehicle (oncoming vehicle 3a) in the oncoming lane of the target lane.

According to (2), when the host vehicle turns left to enter the target lane, the division mark is displayed on condition that there is an oncoming vehicle in the oncoming lane of the target lane, and therefore, unnecessary display is not performed when turning left, thereby improving the ease of driving operations.

(3) The control device according to (1) or (2), in which

when an oncoming lane (oncoming lane 212) of the host lane exists on a roadway (current roadway 210) including the host lane, and a division line separating the host lane and the oncoming lane of the host lane exists or is detected, the processor displays, in the display of the route, a connection mark (guide lines 241) connecting the division mark and the division line separating the host lane and the oncoming lane of the host lane.

According to (3), by displaying the connection mark connecting the division line separating the host lane and the oncoming lane thereof and the division mark separating the target lane and the oncoming lane thereof, it is possible to further improve the ease of driving operations.

(4) The control device according to any of (1) to (3), in which

the host vehicle travels on a first direction side of a road,

when the oncoming lane of the target lane exists on the roadway including the target lane, and the division line separating the target lane and the oncoming lane of the target lane does not exist or is not detected,

when an oncoming lane of the host lane exists on a roadway including the host lane, and a division line separating the host lane and the oncoming lane of the host lane does not exist or is not detected, and

when the host vehicle turns from the host lane in an opposite direction of the first direction to enter the target lane,

the processor displays, in the display of the route,

a first division mark (division mark 231) separating the host lane and the oncoming lane of the host lane, and

a second division mark separating the target lane and the oncoming lane of the target lane.

According to (4), when the host vehicle turns right to enter the target lane, if there is no division line separating the host lane and the oncoming lane thereof, a division mark separating those lanes is displayed, and if there is no division line separating the target lane and the oncoming lane thereof, a division mark separating those lanes is displayed, thereby improving the ease of driving operations and preventing the host vehicle from taking a shortcut on the roadway when entering the target lane.

(5) The control device according to any of (1) to (4), in which

the host vehicle travels on a first direction side of a road,

when the oncoming lane of the target lane exists on the roadway including the target lane, and the division line separating the target lane and the oncoming lane of the target lane does not exist or is not detected,

when an oncoming lane of the host lane exists on a roadway including the host lane, and a division line separating the host lane and the oncoming lane of the host lane does not exist or is not detected, and

when the host vehicle turns from the host lane in the first direction to enter the target lane,

the processor displays, in the display of the route,

a first division mark separating the host lane and the oncoming lane of the host lane, and

a second division mark separating the target lane and the oncoming lane of the target lane in response to presence of an oncoming vehicle in the oncoming lane of the target lane.

According to (5), when the host vehicle turns left to enter the target lane, if there is no division line separating the host lane and the oncoming lane thereof, a division mark separating those lanes is displayed, and if there is no division line separating the target lane and the oncoming lane thereof, a division mark separating those lanes is displayed on condition that there is an oncoming vehicle in the oncoming lane, and therefore, unnecessary display is not performed when turning left, thereby improving the ease of driving operations.

(6) The control device according to (4) or (5), in which

the processor displays, in the display of the route, a connection mark connecting the first division mark and the second division mark.

According to (6), by displaying the connection mark connecting the division mark separating the host lane and the oncoming lane thereof and the division mark separating the target lane and the oncoming lane thereof, it is possible to further improve the ease of driving operations.

(7) A control device, including:

a processor configured to

acquire peripheral information of a host vehicle, and

display, when the host vehicle enters from a host lane in which the host vehicle travels to a target lane connected to the host lane, a route from the host lane to the target lane to an occupant of the host vehicle based on the peripheral information, in which

when an oncoming lane of the host lane exists on a roadway including the host lane and a division line separating the host lane and the oncoming lane of the host lane does not exist or is not detected, the processor displays a division mark separating the host lane and the oncoming lane of the host lane in display of the route.

According to (7), when the host vehicle enters the target lane from the host lane, if there is no division line separating the host lane and the oncoming lane thereof, by displaying a division mark separating those lanes, it is possible to perform appropriate display, thereby improving the ease of driving operations.

(8) The control device according to (7), in which

when an oncoming lane of the target lane exists on a roadway including the target lane, and a division line separating the target lane and the oncoming lane of the target lane exists or is detected, the processor displays, in the display of the route, a connection mark (guide line 241, guide line 243a) connecting the division mark and the division line separating the target lane and the oncoming lane of the target lane.

As in (8), by displaying the connection mark connecting the division mark separating the host lane and the oncoming lane thereof and the division line separating the target lane and the oncoming lane thereof, it is possible to further improve the ease of driving operations.

(9) A control method of a control device including a processor, the processor configured to acquire peripheral information of a host vehicle, and display, when the host vehicle turns right or left from a host lane in which the host vehicle travels to enter a target lane connected to the host lane, a route from the host lane to the target lane to an occupant of the host vehicle based on the peripheral information, the control method including:

displaying, when an oncoming lane of the target lane exists on a roadway including the target lane and a division line separating the target lane and the oncoming lane of the target lane does not exist or is not detected, a division mark separating the target lane and the oncoming lane of the target lane in display of the route.

According to (9), when the host vehicle enters the target lane by turning right or left, if there is no division line separating the target lane and the oncoming lane thereof, by displaying a division mark separating those lanes, it is possible to appropriately display a right or left turn, thereby improving ease of driving operations.

(10) A non-transitory computer-readable storage medium storing a control program for a processor of a control device to perform processing, the processor configured to

acquire peripheral information of a host vehicle, and

display, when the host vehicle turns right or left from a host lane in which the host vehicle travels to enter a target lane connected to the host lane, a route from the host lane to the target lane to an occupant of the host vehicle based on the peripheral information,

the processing including:

displaying, when an oncoming lane of the target lane exists on a roadway including the target lane and a division line separating the target lane and the oncoming lane of the target lane does not exist or is not detected, a division mark separating the target lane and the oncoming lane of the target lane in display of the route.

According to (10), when the host vehicle enters the target lane by turning right or left, if there is no division line separating the target lane and the oncoming lane thereof, by displaying a division mark separating those lanes, it is possible to appropriately display a right or left turn, thereby improving ease of driving operations.

(11) A control method of a control device including a processor, the processor configured to acquire peripheral information of a host vehicle, and display, when the host vehicle enters from a host lane in which the host vehicle travels to a target lane connected to the host lane, a route from the host lane to the target lane to an occupant of the host vehicle based on the peripheral information, the control method including:

displaying, when an oncoming lane of the host lane exists on a roadway including the host lane and a division line separating the host lane and the oncoming lane of the host lane does not exist or is not detected, a division mark separating the host lane and the oncoming lane of the host lane in display of the route.

According to (11), when the host vehicle enters the target lane from the host lane, if there is no division line separating the host lane and the oncoming lane thereof, by displaying a division mark separating those lanes, it is possible to perform appropriate display, thereby improving the ease of driving operations.

(12) A non-transitory computer-readable storage medium storing a control program for a processor of a control device to perform processing, the processor configured to

acquire peripheral information of a host vehicle, and

display, when the host vehicle enters from a host lane in which the host vehicle travels to a target lane connected to the host lane, a route from the host lane to the target lane to an occupant of the host vehicle based on the peripheral information,

the processing including:

displaying, when an oncoming lane of the host lane exists on a roadway including the host lane and a division line separating the host lane and the oncoming lane of the host lane does not exist or is not detected, a division mark separating the host lane and the oncoming lane of the host lane in display of the route.

According to (12), when the host vehicle enters the target lane from the host lane, if there is no division line separating the host lane and the oncoming lane thereof, by displaying a division mark separating those lanes, it is possible to perform appropriate display, thereby improving the ease of driving operations.

What is claimed is:

1. A control device, comprising:
a processor configured to
acquire peripheral information of a host vehicle, and
display, when the host vehicle turns right or left from a host lane in which the host vehicle travels to enter a target lane connected to the host lane, a route from the host lane to the target lane to an occupant of the host vehicle based on the peripheral information, wherein
when an oncoming lane of the target lane exists on a roadway including the target lane and a division line separating the target lane and the oncoming lane of the target lane does not exist or is not detected, the processor displays a division mark separating the target lane and the oncoming lane of the target lane in display of the route.

2. The control device according to claim 1, wherein
the host vehicle travels on a first direction side of a road, and
when the oncoming lane of the target lane exists, and the division line separating the target lane and the oncoming lane of the target lane does not exist or is not detected, and when the host vehicle turns in the first direction and enters the target lane, the processor displays the division mark separating the target lane and the oncoming lane of the target lane in the display of the route in response to presence of an oncoming vehicle in the oncoming lane of the target lane.

3. The control device according to claim 1, wherein
when an oncoming lane of the host lane exists on a roadway including the host lane, and a division line separating the host lane and the oncoming lane of the host lane exists or is detected, the processor displays, in the display of the route, a connection mark connecting the division mark and the division line separating the host lane and the oncoming lane of the host lane.

4. The control device according to claim 1, wherein
the host vehicle travels on a first direction side of a road,
when the oncoming lane of the target lane exists on the roadway including the target lane, and the division line separating the target lane and the oncoming lane of the target lane does not exist or is not detected,
when an oncoming lane of the host lane exists on a roadway including the host lane, and a division line separating the host lane and the oncoming lane of the host lane does not exist or is not detected, and
when the host vehicle turns from the host lane in an opposite direction of the first direction to enter the target lane,
the processor displays, in the display of the route,
a first division mark separating the host lane and the oncoming lane of the host lane, and
a second division mark separating the target lane and the oncoming lane of the target lane.

5. The control device according to claim 1, wherein
the host vehicle travels on a first direction side of a road,
when the oncoming lane of the target lane exists on the roadway including the target lane, and the division line separating the target lane and the oncoming lane of the target lane does not exist or is not detected,
when an oncoming lane of the host lane exists on a roadway including the host lane, and a division line separating the host lane and the oncoming lane of the host lane does not exist or is not detected, and
when the host vehicle turns from the host lane in the first direction to enter the target lane,
the processor displays, in the display of the route,
a first division mark separating the host lane and the oncoming lane of the host lane, and
a second division mark separating the target lane and the oncoming lane of the target lane in response to presence of an oncoming vehicle in the oncoming lane of the target lane.

6. The control device according to claim 4, wherein
the processor displays, in the display of the route, a connection mark connecting the first division mark and the second division mark.

7. A control device, comprising:
a processor configured to
acquire peripheral information of a host vehicle, and
display, when the host vehicle enters from a host lane in which the host vehicle travels to a target lane connected to the host lane, a route from the host lane to the target lane to an occupant of the host vehicle based on the peripheral information, wherein
when an oncoming lane of the host lane exists on a roadway including the host lane and a division line separating the host lane and the oncoming lane of the host lane does not exist or is not detected, the processor displays a division mark separating the host lane and the oncoming lane of the host lane in display of the route.

8. The control device according to claim 7, wherein
when an oncoming lane of the target lane exists on a roadway including the target lane, and a division line separating the target lane and the oncoming lane of the target lane exists or is detected, the processor displays, in the display of the route, a connection mark connecting the division mark and the division line separating the target lane and the oncoming lane of the target lane.

9. A control method of a control device including a processor, the processor configured to acquire peripheral information of a host vehicle, and display, when the host vehicle turns right or left from a host lane in which the host vehicle travels to enter a target lane connected to the host lane, a route from the host lane to the target lane to an occupant of the host vehicle based on the peripheral information, the control method comprising:
displaying, when an oncoming lane of the target lane exists on a roadway including the target lane and a division line separating the target lane and the oncoming lane of the target lane does not exist or is not detected, a division mark separating the target lane and the oncoming lane of the target lane in display of the route.

10. A non-transitory computer-readable storage medium storing a control program for a processor of a control device to perform processing, the processor configured to
acquire peripheral information of a host vehicle, and
display, when the host vehicle turns right or left from a host lane in which the host vehicle travels to enter a target lane connected to the host lane, a route from the host lane to the target lane to an occupant of the host vehicle based on the peripheral information,
the processing comprising:
displaying, when an oncoming lane of the target lane exists on a roadway including the target lane and a division line separating the target lane and the oncoming lane of the target lane does not exist or is not detected, a division mark separating the target lane and the oncoming lane of the target lane in display of the route.
